(19) United States
(12) Patent Application Publication
(10) Pub. No.: US 2015/0013391 A1
(43) Pub. Date: Jan. 15, 2015

(54) METHOD AND APPARATUS FOR PROCESSING EDGE OF GLASS PLATE

(71) Applicant: LAMINEX CO., LTD., Pyeongtaek-si, Gyeonggi-do (KR)

(72) Inventor: Pyoeon Kim, Seoul (KR)

(73) Assignee: LAMINEX CO., LTD., Pyeongtaek-si, Gyeonggi-do (KR)

(21) Appl. No.: 14/366,601

(22) PCT Filed: Jan. 8, 2013
(86) PCT No.: PCT/KR2013/000136

§ 371 Date: Jun. 18, 2014

(30) Foreign Application Priority Data
Jan. 9, 2012 (KR) 10-2012-0002573

(51) Int. Cl. C03B 33/03

(52) U.S. Cl. CPC C03B 33/03
USPC 65/112; 65/348

(57) ABSTRACT

The present invention relates to a method for processing an edge of a glass plate, and more specifically, to a method for processing an edge of a large-sized glass plate used for liquid crystal TVs and the like by means of heat treatment, and an apparatus therefor. The method for processing an edge of a glass plate according to the present invention is characterized by cutting off an edge of a cooled glass plate off while contacting and moving a heated member along the edge of the cooled glass plate.

### CROSS-REFERENCE TO RELATED APPLICATION

This application claims priority to and the benefit of Korean Patent Application No. 10-2012-0002573 filed in the Korean Intellectual Property Office on Jan. 9, 2012, the entire contents of which are incorporated herein by reference.

### BACKGROUND OF THE INVENTION

(a) Field of the Invention

The present invention relates to processing an edge of a glass plate, and in particular, it relates to a method and an apparatus for processing an edge of a large glass plate used for liquid crystal television, etc. by heat treatment.

(b) Description of the Related Art

As disclosed in WO 2005/044512, processing a glass sheet used for a flat panel display and requiring surface finishing generally entails removing sharp portions by grinding and/or polishing an edge of the glass sheet after cutting the glass sheet to necessary shape.

Usual methods for processing and transporting a thin glass plate have several shortcomings. First of all, particles generated during finishing an edge can be main contamination sources against the surface of the thin glass plate. Accordingly, in order to clean and wash out the particles from the thin glass plate, a large scale of cleaning and drying process is required at the last of the finishing. Additional process for cleaning and drying accomplished at the last of the finishing damages the basic cost for finishing line and increases the manufacturing cost. Additionally, the particles and chips between a belt and the thin glass plate can cause serious damage to the surface of the thin glass plate. Occasionally, this damage causes a series of processing step to halt and a productivity to worsen because the amount of shipment for client becomes decreasing.

To overcome the above shortcomings Korean patent publication number 2007-0030167 discloses an apparatus for processing an edge of a sheet of material includes an encapsulation device for supporting two surfaces of the material and a processing device for processing the edge adjacent to the supported two surfaces of the material that is located on a first side of said encapsulation device, and said encapsulation device substantially prevents particles and other contaminants generated when said processing device processes the edge of the material from reaching the two surfaces of the material located on a second side of said encapsulation device. Korean patent publication number 2008-0101261 discloses an apparatus for grinding the edge by using an abrasive stone of diamond equipped to the grinding tools alternately. Korean patent registration number 10-0458537 discloses a method includes installing a nozzle near the chamfering portion, throwing away dust by blowing through the nozzle and sucking the pressurized air including the fine glass particles generate during chamfering.

However, these apparatuses or methods process the edge using grinding or chamfering, accordingly theses cannot avoid a variety of problems including generating the glass dust, damage to the edge during grinding, surface scratch by glass dust, harmfulness of glass dust against workers. Accordingly, a new processing method and apparatus avoiding the generation of the glass dust completely is continuously required.

The inventor of the present invention disclosed Korean patent application number 2010-0051062. As shown in FIG. 1, a method for fusing the edge selectively excluding the bottom 230 of the glass plate 100 by treating the edge of the glass plate 100 with porous 200 flame plate 300 is disclosed. This method is suitable for processing a product having a size of 3˜10 inches like cellphone or tablet PC, but is not suitable for processing a large glass plate having a size above 40 inches like liquid crystal TV and has a problem to warm up the glass plate before processing and require annealing after processing. Accordingly, a new method for processing not only the edge of small glass plate but also the edge of large glass plate is continuously required.

### SUMMARY OF THE INVENTION

An object of the present invention is to provide a new method for processing an edge of a glass plate, capable of removing dust generated during processing of the edge of the glass plate.

Another object of the present invention is to provide a new simple method for processing an edge of a glass plate, not to be needed to use a furnace for heating the glass plate.

In accordance with an aspect of the present invention, there is provided a method for processing an edge of a glass plate, wherein the edge of the glass plate is cut off while contacting a heated member with the edge of the cooled glass plate.

In accordance with the present invention, in order for cooling the edge of the glass plate it is possible to cool the whole parts of the glass plator only edge parts of the glass plate selectively. It is more preferable to cool the whole parts of the glass plate for more stable control. In accordance with the present invention, in order for cooling the glass plate it is possible to place the glass plate for pre-determined time in a working environment which maintains low temperature, or contact the glass plate with a cooling plate which maintains low temperature. It is more preferable to cut off the glass plate while fixing the glass plate with the cooling plate which maintains pre-determined temperature in order to avoid rising temperature of the glass plate during processing.

In accordance with the present invention, the cooling plate can include a passageway through which coolant of low temperature flows and a plurality of attracting holes penetrating the cooling plate. The glass plate can be vacuum-attracted to the cooling plate.

In accordance with the present invention, the low-temperature can mean temperature lower than normal temperature (about 25° C.), more preferably, lower than normal temperature at least by 10° C. In accordance with the present invention, temperature of the glass plate can be preferably below 10° C., more preferably in the range of 0˜10° C. in order to save energy for excessive cooling.

In accordance with an aspect of the present invention, in case that the temperature of the glass plate is high, it can be hard to etch the edge of the thin glass plate accurately due to a large amount of the glass to be cut off. In case that the temperature of the glass is low, it can be hard to control the processing stably due to excessive energy consumption.

In accordance with an aspect of the present invention, the “heated” means that the temperature of the member rises above a glass transition temperature (Tg). The Tg of the glass varies from 750° C. to 1300° C. depending on the type of the glass.

In accordance with an aspect of the present invention, the temperature of the heated member can be maintained over 50° C., preferably over 100° C., more preferably over 200˜500° C. than Tg of the glass.

In accordance with an aspect of the present invention, the contacting means that the cooled glass plate and the heated member contact physically with each other, substantially, contact and are pressurized with weak pressure. In accordance with an aspect of the present invention, it is preferable that the heated member and the glass plate are pressurized with pressure of 0.1˜3.0 Kg_{f}/cm², more preferably 0.5˜1.5 Kg_{f}/cm². In case that the pressure is excessively high, it cannot be suitable for processing the edge of the thin glass plate due to a large amount of the glass to be cut off. In case that the pressure is excessively low, it can curtail productivity of the large thin glass plate for TV etc. due to a small amount of the glass to be cut off.

It is preferable that the heated member has a horseshoe shape in order to prevent the contacting pressure to the edge from changing due to thermal expansion of the heated member during heating and cooling process. It is preferable that the edge of the glass plate contacts with a side surface of the horseshoe-shaped heated member.

It is preferable that the heated member maintains constant temperature in order to prevent an amount of glass to be cut off from changing or the edge from damaging due to temperature drop of a heater while contacting with the edge of the cooled glass plate. Accordingly for the heated member, an electric heater, for example, the heated member having an electric resistance capable of controlling heat discharge rate depending on electric current can be suitable.

In case that the edge of the glass plate contacts at the same portion of the electric resistance, even if it is an electric heater, the temperature of the contacting portion can fall consistently. To prevent these problems, it is preferable to change the contacting portion by moving the electric resistance above and below perpendicularly to the moving direction of the glass plate.

The moving of the glass plate is relative to the heated member. The glass plate can move, or the heated member can move, or the glass plate and the heated member can move simultaneously. The moving rate of the glass plate can be adjusted depending on the productivity, cutting depth, temperature and pressure difference.

In accordance with an aspect of the present invention, the edge of the glass plate can be cut off in a range of 50 μm to 5 mm, more preferably 0.1 mm to 3 mm along the horizontal plane and the perpendicular plane at the edge where the horizontal plane and the perpendicular plane are crossed. The edge of the glass plate can be cut off to a strip shape so that the secondary damage by glass dust or glass particle can be prevented.

In accordance with an aspect of the present invention, it is preferable that the temperature of the glass plate is 0˜10° C., the temperature of the heated member is Tg+200° C. to Tg+500° C., the pressure of the heated member is 0.1˜3 Kg_{f}/cm², and the moving rate of the glass plate is 0.5˜5 cm/s so that the edge of the glass plate can be cut off in a range of about 0.1˜3 mm respectively.

In accordance with an aspect of the present invention, there is provided a method for processing an edge of a glass plate, wherein the edge of the glass plate can be cut off to a strip shape while the edge of the moving and cooled glass plate contacts with a heated member.

In accordance with an aspect of the present invention, there is provided an apparatus for processing an edge of a glass plate include: a glass plate, a movable cooling substrate to which the glass plate mounted, and a heated member having an electric heater to which the edge of the glass plate contacted while moving.

The glass plate and the heated member can move relatively, preferably the glass plate can move. The moving rate of the glass plate can be adjusted depending on the type of the heated glass plate, the temperature of the heated member, and the cutting portion.

In accordance with the aforementioned structure of the present invention, there is provided a new method, capable of cutting off an edge of a glass plate to a strip shape without generating dust. Additionally, the method in accordance with the present invention it needs no large furnace because the glass plate needs not to be heated to high temperature, and the manufacturing process is highly simplified because the post-processing like warm up or annealing is not necessary.

### BRIEF DESCRIPTION OF THE DRAWINGS

FIG. 1 shows a drainpipe (middle portion separated type) in accordance with a first exemplary embodiment of the present invention.

FIG. 2 is a cross sectional view of a cooling bed for cooling and moving a glass plate, in accordance with an exemplary embodiment of the present invention.

FIG. 3 shows change of a horseshoe-shaped heated member contacting with the glass plate due to thermal expansion, in accordance with an exemplary embodiment of the present invention.

FIG. 4 shows contacting state of the cooling bed, the glass plate and the heated member, in accordance with an exemplary embodiment of the present invention.

FIG. 5 is a picture of the glass plate cut off its edge and a cutting chip cut off from the edge, in accordance with an exemplary embodiment of the present invention.

FIG. 6 is a cross sectional view of the contacting state of the glass plate and the heated member.

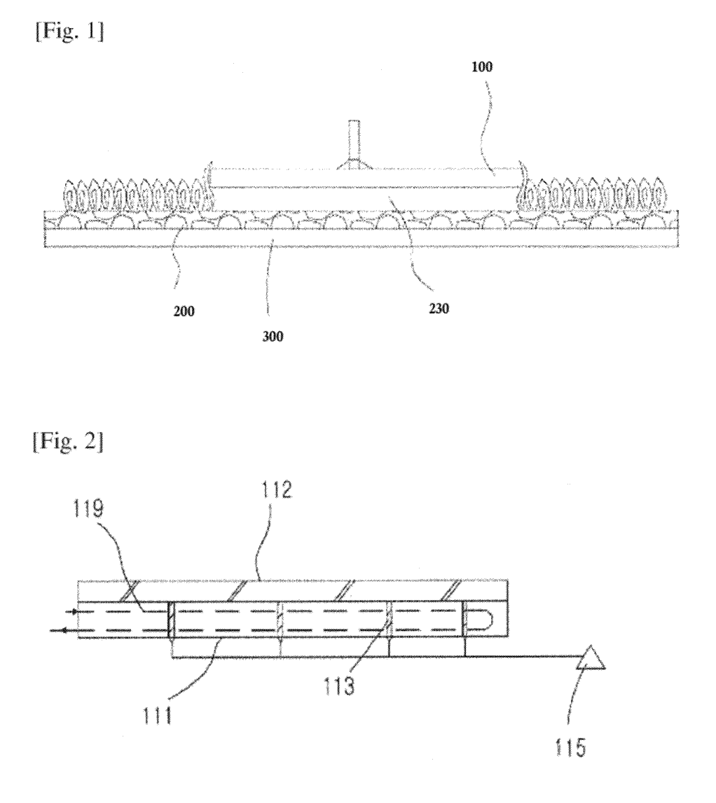

### DETAILED DESCRIPTION OF THE EMBODIMENTS

An exemplary embodiment of the present invention will be described in detail with reference to the accompanying drawings. The drawings and detailed description are only examples of the present invention, serve only for describing the present invention and by no means limit or restrict the spirit and scope of the present invention. Accordingly, it will be appreciated by any person of ordinary skill in the art that a large number of modifications, permutations and additions are possible within the principles and spirit of the invention, the scope of which shall be defined by the appended claims and their equivalents.

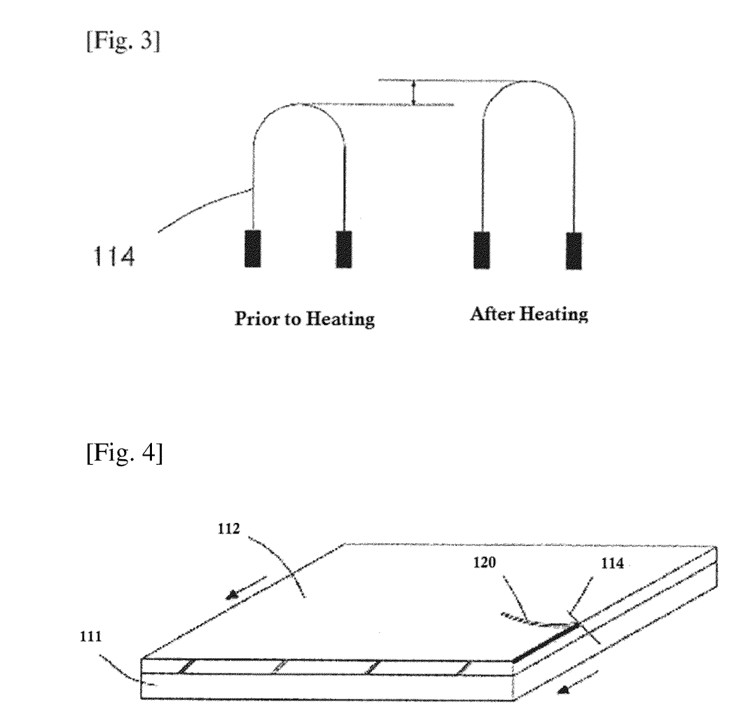

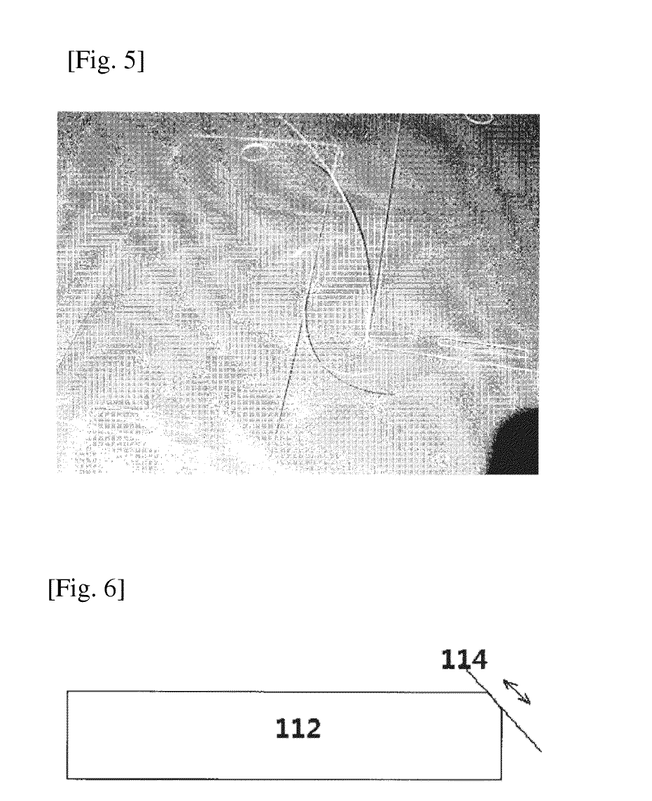

FIG. 2 is a cross sectional view of a cooling bed for cooling and moving a glass plate, in accordance with an exemplary embodiment of the present invention, FIG. 3 shows change of a horseshoe-shaped heated member contacting with the glass plate due to thermal expansion, in accordance with an exemplary embodiment of the present invention, FIG. 4 shows contacting state of the cooling bed, the glass plate and the heated member, in accordance with an exemplary embodiment of the present invention, FIG. 5 is a picture of the glass plate cut off its edge and a cutting chip cut off from the edge, in accordance with an exemplary embodiment of the present invention.

As shown in FIG. 2, a glass plate 112 is placed on the upper portion of a cooling bed 111. It is preferable that the size of the cooling bed 111 is substantially equal to that of the glass plate 111 but can be larger or smaller depending on the embodiment condition. In order to maintain the temperature of the cooling bed 111 constantly, a circulation passageway 120 for coolant is formed in the cooling bed 111. Additionally, attracting holes 113 attracting and fixing the glass plate 112 are formed on the surface of the cooling bed 111. These attracting holes 113 are through holes penetrating the cooling bed 111 from its upper surface to its lower surface, and connected to a vacuum pump 115 generating vacuum state. In case of vacuum-attracting to the bottom of the glass plate, there is no need to install a fixing member to the side portion of the glass plate 112 for fixing, and along the edge of all side surface of the glass plate 112 a heated member can be contacted smoothly.

As shown in FIG. 3, it is preferable that a heated member 114 adjusts its temperature by applying current to its both ends and has a horseshoe shape. The linear portion of the heated member is contacted with the glass plate 112. In case that the temperature rises the horseshoe-shaped heated member increases only in length, as shown in FIG. 3, and has no effect on the contacting with the glass plate 112 so that the glass plate 112 and the heated member 114 can contact with each other stably.

The glass plate 112 having its diagonal length of 42 inches was placed on the cooling bed 114, and the surface temperature of the glass plate was maintained at 7˜8° C. by controlling the temperature of the coolant flowing through the cooling bed 114. The horseshoe-shaped heated member 114 was heated to 950° C. As shown in FIG. 4, the edge was cut off from the glass plate 112 while the cooling bed 114 moved slowly and the edge of the glass plate 112 moved and contacted with the heated member 114. As shown in FIG. 5, the edge of the glass plate 112 was cut off to a strip shape 120 without generating dust.

1. A method for processing an edge of a glass plate, wherein the edge of the glass plate is cut off while contacting a heated member with the edge of the cooled glass plate.

2. The method of claim 1, wherein the edge of the glass plate is cut off to a strip shape.

3. The method of claim 1, wherein the heated member has a higher temperature than a glass transition temperature (Tg).

4. The method of claim 1, wherein the glass plate is maintained between the temperature of 0˜10° C.

5. The method of claim 1, wherein the glass plate moves and contacts with the heated member while attracting to a low-temperature substrate.

6. The method of claim 1, wherein the edge of the glass plate is cooled selectively.

7. An apparatus for processing an edge of a glass plate comprising:
a glass plate;
a movable cooling substrate to which the glass plate mounted; and
a heated member having an electric heater to which the edge of the glass plate contacted while moving.

8. The apparatus of claim 7, wherein the cooling substrate includes an attracting plate attracting the glass plate, and a cooling plate placed under the attracting plate.

9. The apparatus of claim 7, wherein the heated member has a horseshoe shape.

10. The apparatus of claim 7, wherein the heated member has the electric heater heated to a higher temperature than a glass transition temperature (Tg), and the glass plate is cooled to a range of 0˜10° C.

11. The apparatus of claim 7, wherein the heated member moves perpendicularly to a moving direction of the glass plate.
